(19) United States
(12) Patent Application Publication
(10) Pub. No.: US 2010/0250394 A1
(43) Pub. Date: Sep. 30, 2010

(54) Method and system of online auction using blog

(76) Inventor: Nankuei Lin, Taipei (TW)

Correspondence Address: SAM CHEN, 7F-1, 293, ROOSEVELT ROAD, SEC 3, TAIPEI, TW

(21) Appl. No.: 12/409,528

(22) Filed: Mar. 24, 2009

(51) Int. Cl. G06Q 30/00; G06F 17/30; G06Q 20/00; G06F 15/16

(52) U.S. Cl. 705/27; 705/34; 709/204; 707/E17.044

(57) ABSTRACT

Methods of online auction are provided by cooperating with a system including user terminals, seller terminals, web servers each including seller blogs each having an item description web page, an online billing platform, and bank terminals connected together via the Internet. In one embodiment of the methods, a representative of a bidding group may participate the online bidding.

### BACKGROUND OF THE INVENTION

1. Field of Invention

The invention relates to e-business and more particularly to method and system of online auction (i.e., buyers making bids (offers) and the highest offer being accepted as a sale on the Internet) using a blog.

2. Description of Related Art

A blog is a type of personal diary posted on the Internet. Most blogs consist of small, plentiful entries. Topics posted on blogs may vary widely.

Conventionally, e-business is not possible using blog. This is because only data like pictures and documents are typically transmitted by a web server. High cost and technological difficulties make e-business using blog almost infeasible.

Currently, there are many websites providing online shopping. Typically, an item and a brief description thereof are shown on a web page. Hence, a would-be buyer may not know details of a desired item by simply viewing the web page. This may greatly decrease buying desire of many would-be buyers. A lot of restrictions are also applied on web pages provided by the online auction and shopping websites. This may further frustrate many would-be sellers.

Thus, it is desirable to provide a novel method and system of online auction using a blog in order to fully utilize the features of blog.

### SUMMARY OF THE INVENTION

It is therefore one object of the invention to provide a method of online auction using a blog.

It is another object of the invention to provide a system of online auction using a blog.

The above and other objects, features and advantages of the invention will become apparent from the following detailed description taken with the accompanying drawings.

### BRIEF DESCRIPTION OF THE DRAWINGS

FIG. 1 is a block diagram schematically depicting a first preferred embodiment of system of online auction using blog according to the invention;

FIG. 2 is a block diagram schematically depicting the online billing platform of FIG. 1;

FIG. 3 is a block diagram schematically depicting a second preferred embodiment of system of online auction using blog according to the invention;

FIG. 4 is a block diagram schematically depicting the online billing platform of FIG. 3;

FIG. 5 is a block diagram schematically depicting a third preferred embodiment of system of online auction using blog according to the invention; and

FIG. 6 is a block diagram schematically depicting the online billing platform of FIG. 5.

### DETAILED DESCRIPTION OF THE INVENTION

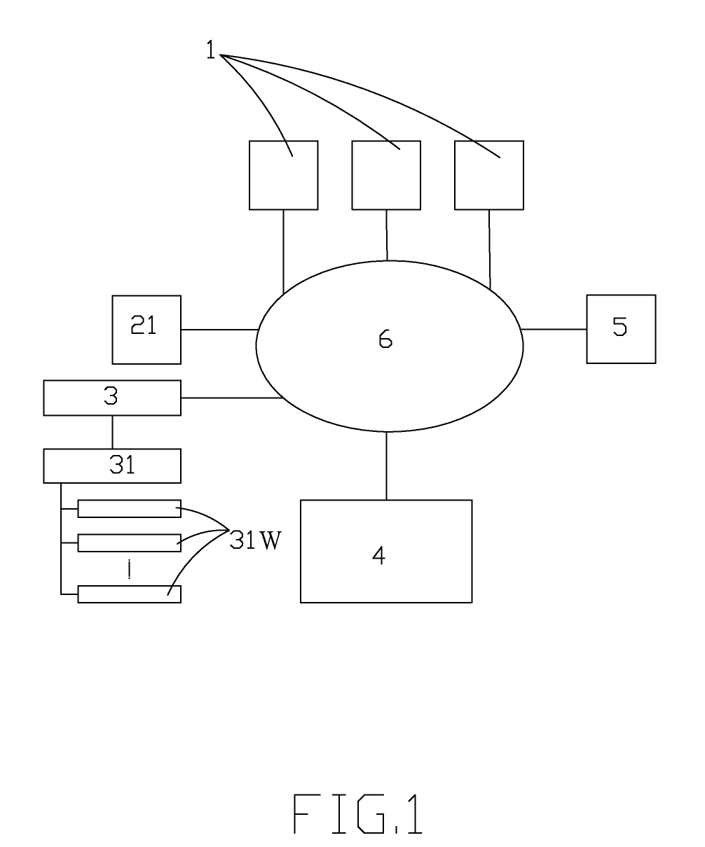

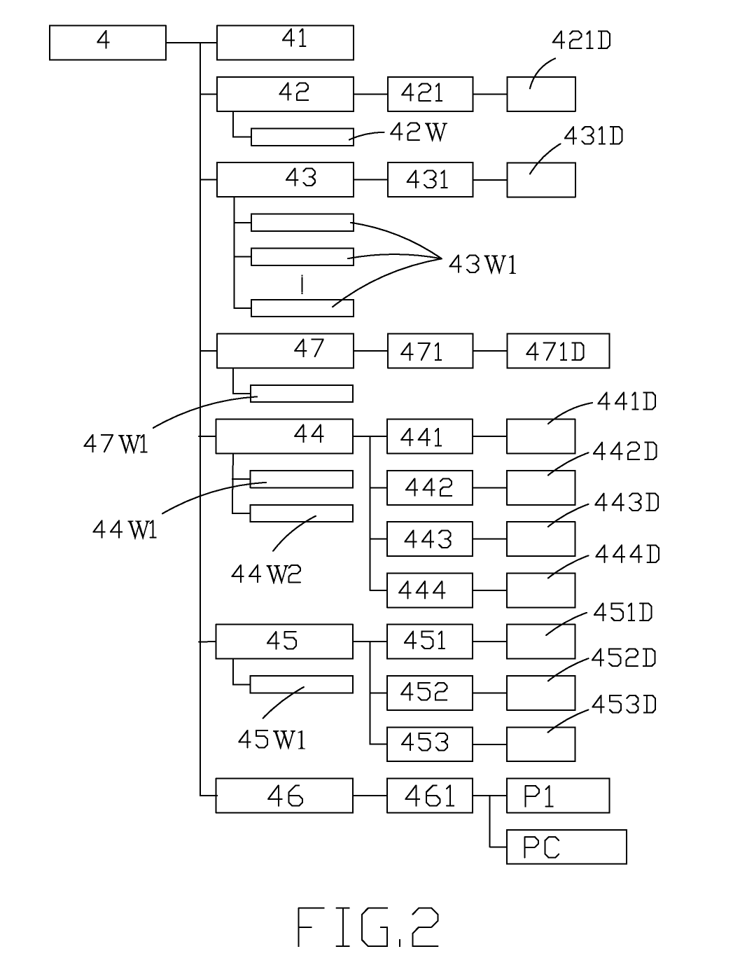

Referring to FIGS. 1 and 2, a system of online auction using blog in accordance with a first preferred embodiment of the invention is shown. The system comprises a plurality of user terminals 1, a plurality of seller terminals (only one is shown) 21, a plurality of web servers (only one is shown) 3, an online billing platform 4, and a plurality of bank terminals (only one is shown) 5 all being connected together via the Internet 6.

The web server 3 comprises a plurality of seller blogs (only one is shown) 31. The online billing platform 4 comprises a platform server 41, a login server 42, an item server 43, a billing server 44, an e-mail server 45, a function server 46, and a transaction server 47 all being connected together by wires.

The login server 42 comprises a member database 421. The item server 43 comprises a merchandise database 431. The transaction server 47 comprises a group bidding database 47. The billing server 44 comprises a purchase order database 441, a bank database 442, a shipment database 443, and a request for payment database 444. The e-mail server 45 comprises an e-mail database 451, a client database 452, and an advertisement database 453. The function server 46 comprises a program database 461 having a group bidding tab program P1. The group bidding tab program P1 comprises a guide tab, a group bidding confirmation tab, and an information display tab.

The method of online auction using blog in accordance with a first preferred embodiment of the invention comprises the following steps.

A seller may use a seller terminal 21 to access a seller blog 31 of the web server 3 over the Internet 6. The seller then creates an item description web page 31W in the seller blog 31. A number of pictures and accompanying description of items being auctioned are posted on the item description web page 31W. The seller then uses the seller terminal 21 to access the platform server 41 via the Internet 6. Next, the seller gains access to a member web page 42W of the login server 42 and types personal data for membership application.

After becoming a member, a seller may gain access to the platform server 41 via the Internet 6. Next, it is connected to the login server 42. Next, user name and password are typed for identification. After being identified, the seller may gain access to the program database 461. Next, program codes of the group bidding tab program P1 are copied to the seller terminal 21 based on his or her rights and a desired bid mode. Next, the seller may use the seller terminal 21 to link to a seller blog 31. After successfully linking, the seller may copy program codes of the group bidding tab program P1 to the seller blog 31. Thus, program codes of the group bidding tab program P1 may be installed in the item description web page 31W. Also, the guide tab of the group bidding tab program P1 is installed in the item description web page 31W.

A seller may click the guide tab of the item description web page 31W of the seller blog 31 to link the item description web page 31W of the seller blog 31 to the platform server 41 of the online billing platform 4 via the Internet 6. Next, it is linked to the login server 42. Next, user name and password are typed for identification. After being identified, the seller is linked to the item server 43. Next, a number of pictures and accompanying description of items being auctioned on the item description web page 31W of the seller blog 31 are downloaded to the merchandise database 431 of the item server 43. Next, a merchandise file 431D is created in the merchandise database 431. Tab program codes PC are created in the program database 461. Next, the seller may obtain the tab program codes PC by linking to the program database 461. Next, the seller may use the seller terminal 21 to link to the seller blog 31 and copy the tab program codes PC to the seller blog 31. The group bidding confirmation tab and the information display tab are contained in the item description web page 31W. A representative for a bidding group may click the group bidding confirmation tab to start a group bidding procedure. After starting the group bidding procedure, the information display tab may show remaining time of collecting bids, current prices of all available items, and the number of sold items on the item description web page 31W immediately.

A plurality of merchandise sale web pages 43W1 are created by the merchandise file 431D. Also, the group bidding confirmation tab, the information display tab, and a link tab are contained in the merchandise sale web page 43W1. The representative for the bidding group may click the group bidding confirmation tab to start a group bidding procedure. Also, the representative may click the link tab to link the platform server 41 of the online billing platform 4 to the item description web page 31W of the seller blog 31 in order to view details of pictures and accompanying description of items being auctioned. The information display tab may show remaining time of collecting bids, current prices of all available items, and the number of sold items on the merchandise sale web page 43W1 immediately.

The representative for the bidding group may use a user terminal 1 to link to a seller blog 31 so as to view the pictures and accompanying description of items being auctioned on the item description web page 31W of the seller blog 31. For bidding one or more desired items, the representative may click the group bidding confirmation tab on the item description web page 31W to start a group bidding procedure when the time of collecting bids has not expired.

Alternatively, the representative may use a user terminal 1 to link to a platform server 41 of the online billing platform 4 and in turn link to an item server 43 in order to view pictures and accompanying description of items being auctioned on the merchandise sale web page 43W1 of the item server 43. For bidding one or more items posted on the merchandise sale web page 43W1, the representative may click the group bidding confirmation tab on the merchandise sale web page 43W1 to start a group bidding procedure when the time of collecting bids has not expired.

Still alternatively, the representative may click the link tab on the merchandise sale web page 43W1 to link the platform server 41 to the item description web page 31W in order to view pictures and accompanying description of items being auctioned thereon.

The group bidding confirmation tab will be disabled immediately when the time of collecting bids has expired. A group bidding confirmation file with group bid number 471D is created in the group bidding database 471. The e-mail server 45 sends an e-mail containing a payment tab to the representative after finishing the group bidding procedure based on the group bidding confirmation file with group bid number 471D. The representative may click the payment tab to start a payment procedure.

The method of online auction using blog further comprises the following steps:

The seller may use a seller terminal 21 to link to a platform server 41 of the online billing platform 4 and in turn link to a login server 42. Next, user name and password are typed for identification. After being identified, the seller may link to an e-mail server 45 to send a client file to a client database 452 of the e-mail server 45. And in turn, a corresponding client record file 452D is created. The e-mail server 45 of the online billing platform 4 may create an advertisements issuing web page 45W1 based on the client record file 452D and the merchandise file 431D.

The seller may use a seller terminal 21 to link to a platform server 41 of the online billing platform 4 and in turn link to a login server 42. Next, user name and password are typed for identification. After being identified, the seller may link to an advertisements issuing web page 45W1 of an e-mail server 45. Also, the seller is required to input a client list and information about merchandise being auctioned on the advertisements issuing web page 45W1 required for advertisement purposes. A issued advertisements file 453D is created in the advertisement database 453 of the e-mail server 45 based on the client list and information about merchandise being auctioned. The e-mail server 45 then sends the issued advertisements file 453D to the representative for a bidding group by e-mail. Note that the group bidding confirmation tab contained in the e-mail has been enabled. Hence, the representative may click the group bidding confirmation tab to start a group bidding procedure.

A group bidding procedure involves the following steps: A representative for a bidding group may click the group bidding confirmation tab to link to a platform server 41 of the online billing platform 4 and in turn link to a login server 42. Next, user name and password are typed for identification. After being identified, the representative may link to a group bidding confirmation web page 47W1 of the transaction server 47. Also, the representative is required to input payment data on the group bidding confirmation web page 47W1. A group bidding confirmation file with group bid number 471D is created in the group bidding database 471 of the transaction server 47 based on the payment data.

Further, the e-mail server 45 sends an e-mail containing a payment tab to the representative after finishing the group bidding procedure based on the group bidding confirmation file with group bid number 471D. The transaction server 47 then links to the information display tab on the item description web page 31W via the platform server 41. The transaction server 47 then updates current prices of all available items, and the number of sold items on the item description web page 31W immediately based on the group bidding confirmation file with group bid number 471D.

A payment procedure involves the following steps: A representative for a bidding group may use the user terminal 1 to click the payment tab contained in the e-mail to link to a platform server 41 of the online billing platform 4 and in turn link to a login server 42. Next, user name and password are typed for identification. After being identified, the user may link to a payment web page 44W1 of a billing server 44. Also, the representative is required to input payment data on the payment web page 44W1. A purchase order file with order number 441D is created in the purchase order database 441 of the billing server 44 based on the payment data.

The platform server 41 of the online billing platform 4 links to a bank terminal 5. The billing server 44 then verifies information (e.g., credit card information) provided in the purchase order file with order number 441D with a corresponding credit card issuing bank. After being verified, a transaction particulars file with order number 442D is created in a bank database 442 of the billing server 44 based on an authorization from the bank. Also, a shipment file with order number 443D is created in the shipment database 443 of the billing server 44.

The e-mail server 45 then sends the purchase order file with order number 441D to the representative by e-mail. Also, the e-mail server 45 then sends an e-mail to inform the seller to prepare the ordered item for shipment based on the shipment file with order number 443D.

The method of online auction using blog further comprises the following steps:

After successfully shipping the goods, the seller may use a seller terminal 21 to link to a platform server 41 of the online billing platform 4 and in turn link to a login server 42. Next, user name and password are typed for identification. After being identified, the seller may link to a request for payment web page 44W2 of the billing server 44. Also, the seller is required to input request for payment data on the request for payment web page 44W2. A debit note file with order number 444D is created in the request for payment database 444 of the billing server 44 based on the request for payment data.

After being verified by a manager of the online billing platform 4, an invoice is prepared based on the debit note file with order number 444D. The invoice is finally issued to the buyer (i.e., the representative for the winning bidding group) for request for payment.

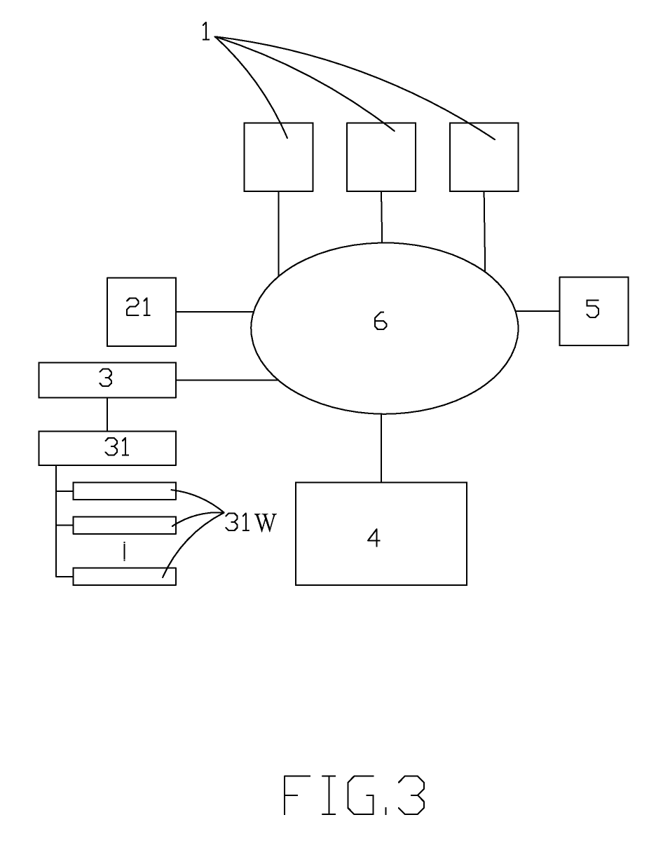

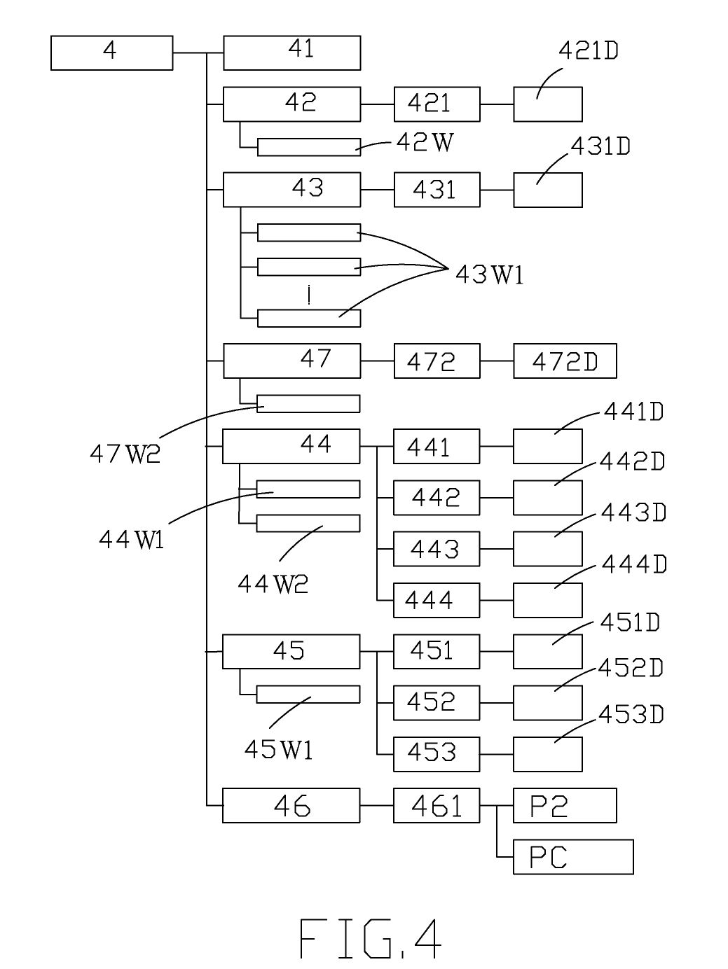

Referring to FIGS. 3 and 4, a system of online auction using blog in accordance with a second preferred embodiment of the invention is shown. The system comprises a plurality of user (i.e., seller) terminals 1, a plurality of seller terminals 21, a plurality of web servers (only one is shown) 3, an online billing platform 4, and a plurality of bank terminals (only one is shown) 5 all being connected together via the Internet 6.

The web server 3 comprises a plurality of seller blogs 31. The online billing platform 4 comprises a platform server 41, a login server 42, an item server 43, a billing server 44, an e-mail server 45, a function server 46, and a transaction server 47 all being connected together by wires.

The login server 42 comprises a member database 421. The item server 43 comprises a merchandise database 431. The transaction server 47 comprises an auction database 472. The billing server 44 comprises a purchase order database 441, a bank database 442, a shipment database 443, and a request for payment database 444. The e-mail server 45 comprises an e-mail database 451, a client database 452, and an advertisement database 453. The function server 46 comprises a program database 461 having an auction tab program P2. The auction tab program P2 comprises a guide tab, a bid price confirmation tab, and an information display tab.

The method of online auction using blog in accordance with a first preferred embodiment of the invention comprises the following steps.

A seller may use a seller terminal 21 to access a seller blog 31 of the web server 3 over the Internet 6. The seller then creates an item description web page 31W in the seller blog 31. A number of pictures and accompanying description of items being auctioned are posted on the item description web page 31W. The seller then uses the seller terminal 21 to access the platform server 41 via the Internet 6. Next, the seller gains access to a member web page 42W of the login server 42 and types personal data for membership application.

After becoming a member, a seller may gain access to the platform server 41 via the Internet 6. Next, it is connected to the login server 42. Next, user name and password are typed for identification. After being identified, the seller may gain access to the program database 461. Next, program codes of the auction tab program P2 are copied to the seller terminal 21 based on his or her rights and a desired bid mode. Next, the seller may use the seller terminal 21 to link to a seller blog 31. After successfully linking, the seller may copy program codes of the auction tab program P2 to the seller blog 31. Thus, program codes of the auction tab program P2 may be installed in the item description web page 31W. Also, the guide tab of the auction tab program P2 is installed in the item description web page 31W.

A seller may click the guide tab of the item description web page 31W of the seller blog 31 to link the item description web page 31W of the seller blog 31 to the platform server 41 of the online billing platform 4 via the Internet 6. Next, it is linked to the login server 42. Next, user name and password are typed for identification. After being identified, the seller is linked to the item server 43. Next, a number of pictures and accompanying description of items being auctioned on the item description web page 31W of the seller blog 31 are downloaded to the merchandise database 431 of the item server 43. Next, a merchandise file 431D is created in the merchandise database 431. Tab program codes PC are created in the program database 461. Next, the seller may obtain the tab program codes PC by linking to the program database 461. Next, the seller may use the seller terminal 21 to link to the seller blog 31 and copy the tab program codes PC to the seller blog 31. The bid price confirmation tab and the information display tab are contained in the item description web page 31W. A bidder may click the bid price confirmation tab to start a bidding procedure. After starting the bidding procedure, the information display tab may show remaining time of collecting bids, current prices of all available items, and the number of sold items on the item description web page 31W immediately.

A plurality of merchandise sale web pages 43W1 are created by the merchandise file 431D. Also, the bid price confirmation tab, the information display tab, and a link tab are contained in the merchandise sale web page 43W1. The bidder may click the bid price confirmation tab to start a bidding procedure. Also, the bidder may click the link tab to link the platform server 41 of the online billing platform 4 to the item description web page 31W of the seller blog 31 in order to view details of pictures and accompanying description of items being auctioned. The information display tab may show remaining time of collecting bids, current prices of all available items, and the number of sold items on the merchandise sale web page 43W1 immediately.

The bidder may use a user terminal 1 to link to a seller blog 31 so as to view the pictures and accompanying description of items being auctioned on the item description web page 31W of the seller blog 31. For bidding one or more desired items, the bidder may click the bid price confirmation tab on the item description web page 31W to start a bidding procedure when the time of collecting bids has not expired.

Alternatively, the bidder may use a user terminal 1 to link to a platform server 41 of the online billing platform 4 and in turn link to an item server 43 in order to view pictures and accompanying description of items being auctioned on the merchandise sale web page 43W1 of the item server 43. For bidding one or more items posted on the merchandise sale web page 43W1, the bidder may click the bid price confirmation tab on the merchandise sale web page 43W1 to start a bidding procedure when the time of collecting bids has not expired.

Still alternatively, the bidder may click the link tab on the merchandise sale web page 43W1 to link the platform server 41 to the item description web page 31W in order to view pictures and accompanying description of items being auctioned thereon.

The bid price confirmation tab will be disabled immediately when the time of collecting bids has expired. A bid price confirmation file with bid number 472D is created in the auction database 472. The e-mail server 45 sends an e-mail containing a payment tab to the bidder after finishing the bidding procedure based on the bid price confirmation file with bid number 472D. The bidder may click the payment tab to start a payment procedure.

The method of online auction using blog further comprises the following steps:

The seller may use a seller terminal 21 to link to a platform server 41 of the online billing platform 4 and in turn link to a login server 42. Next, user name and password are typed for identification. After being identified, the seller may link to an e-mail server 45 to send a client file to a client database 452 of the e-mail server 45. And in turn, a corresponding client record file 452D is created. The e-mail server 45 of the online billing platform 4 may create an advertisements issuing web page 45W1 based on the client record file 452D and the merchandise file 431D.

The seller may use a seller terminal 21 to link to a platform server 41 of the online billing platform 4 and in turn link to a login server 42. Next, user name and password are typed for identification. After being identified, the seller may link to an advertisements issuing web page 45W1 of an e-mail server 45. Also, the seller is required to input a client list and information about merchandise being auctioned on the advertisements issuing web page 45W1 required for advertisement purposes. A issued advertisements file 453D is created in the advertisement database 453 of the e-mail server 45 based on the client list and information about merchandise being auctioned. The e-mail server 45 then sends the issued advertisements file 453D to the bidder by e-mail. Note that the bid price confirmation tab contained in the e-mail has been enabled. Hence, the bidder may click the bid price confirmation tab to start a bidding procedure.

A bidding procedure involves the following steps: A bidder may click the bid price confirmation tab to link to a platform server 41 of the online billing platform 4 and in turn link to a login server 42. Next, user name and password are typed for identification. After being identified, the bidder may link to a bid price confirmation web page 47W2 of the transaction server 47. Also, the bidder is required to input payment data on the bid price confirmation web page 47W2. A bid price confirmation file with bid number 472D is created in the auction database 472 of the transaction server 47 based on the payment data.

Further, the e-mail server 45 sends an e-mail containing a payment tab to the bidder after finishing the bidding procedure based on the bid price confirmation file with bid number 472D. The transaction server 47 then links to the information display tab on the item description web page 31W via the platform server 41. The transaction server 47 then updates current prices of all available items, and the number of sold items on the item description web page 31W immediately based on the bid price confirmation file with bid number 472D.

A payment procedure involves the following steps: A bidder may use the user terminal 1 to click the payment tab contained in the e-mail to link to a platform server 41 of the online billing platform 4 and in turn link to a login server 42. Next, user name and password are typed for identification. After being identified, the user may link to a payment web page 44W1 of a billing server 44. Also, the bidder is required to input payment data on the payment web page 44W1. A purchase order file with order number 441D is created in the purchase order database 441 of the billing server 44 based on the payment data.

The platform server 41 of the online billing platform 4 links to a bank terminal 5. The billing server 44 then verifies information (e.g., credit card information) provided in the purchase order file with order number 441D with a corresponding credit card issuing bank. After being verified, a transaction particulars file with order number 442D is created in a bank database 442 of the billing server 44 based on an authorization from the bank. Also, a shipment file with order number 443D is created in the shipment database 443 of the billing server 44.

The e-mail server 45 then sends the purchase order file with order number 441D to the bidder by e-mail. Also, the e-mail server 45 then sends an e-mail to inform the seller to prepare the ordered item for shipment based on the shipment file with order number 443D.

The method of online auction using blog further comprises the following steps:

After successfully shipping the goods, the seller may use a seller terminal 21 to link to a platform server 41 of the online billing platform 4 and in turn link to a login server 42. Next, user name and password are typed for identification. After being identified, the seller may link to a request for payment web page 44W2 of the billing server 44. Also, the seller is required to input payment data on the request for payment web page 44W2. A debit note file with order number 444D is created in the request for payment database 444 of the billing server 44 based on the payment data.

After being verified by a manager of the online billing platform 4, an invoice is prepared based on the debit note file with order number 444D. The invoice is finally issued to the buyer (i.e., the winning bidder) for request for payment.

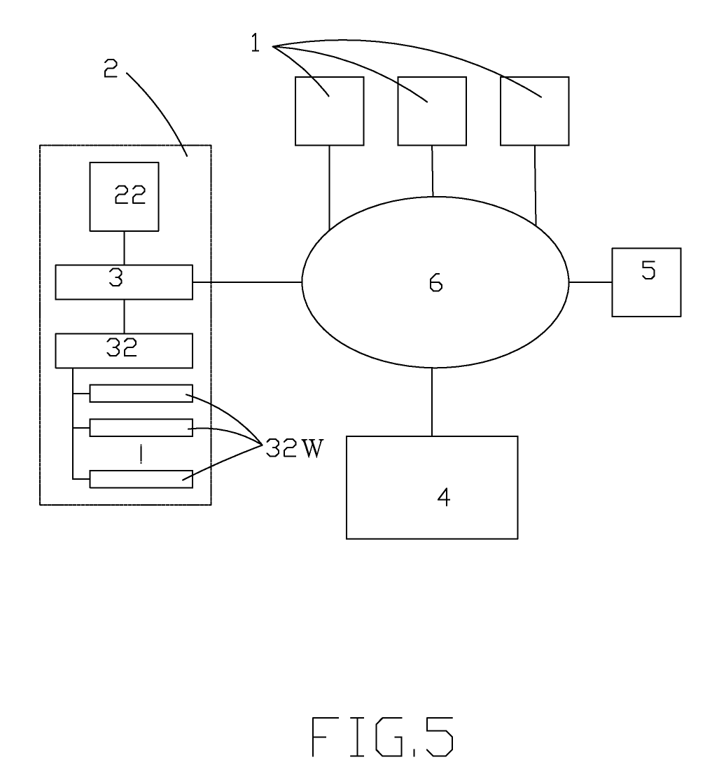

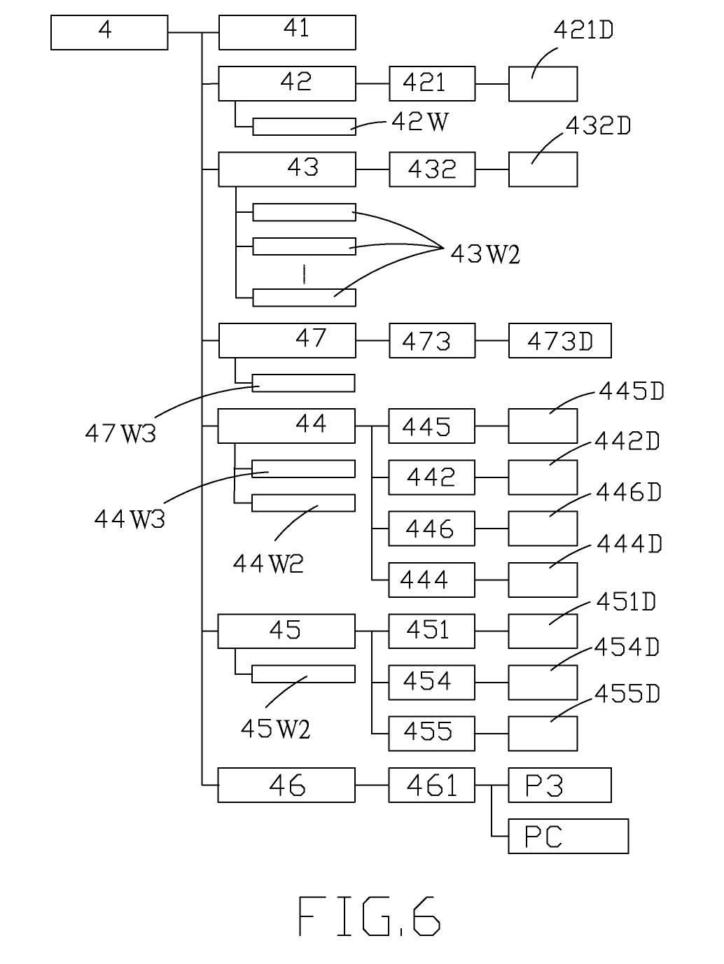

Referring to FIGS. 5 and 6, a system of online auction using blog in accordance with a third preferred embodiment of the invention is shown. The system comprises a plurality of user terminals 1, a plurality of provider web sites (only one is shown) 2, an online billing platform 4, and a plurality of bank terminals (only one is shown) 5 all being connected together via the Internet 6.

The provider web site comprises a provider terminal 22 and a web server 3.

The web server 3 comprises a provider blog 32. The online billing platform 4 comprises a platform server 41, a login server 42, an item server 43, a billing server 44, an e-mail server 45, a function server 46, and a transaction server 47 all being connected together by wires.

The login server 42 comprises a member database 421. The item server 43 comprises a bid database 432. The transaction server 47 comprises an invitation to bid database 473. The billing server 44 comprises a bid list database 445, a bank database 442, a bidding contract database 446, and a request for payment database 444. The e-mail server 45 comprises an e-mail database 451, a supplier database 454, and an publication database 455. The function server 46 comprises a program database 461 having an invitation to bid program P3. The invitation to bid program P3 comprises a guide tab, a bid confirmation tab, and an information display tab.

The method of online auction using blog in accordance with a first preferred embodiment of the invention comprises the following steps.

A bid provider may use a provider terminal 22 to access a provider blog 32 of the web server 3 over the Internet 6. The bid provider then creates a bid description web page 32W in the provider blog 32. A number of pictures and accompanying description of available bids are posted on the bid description web page 32W. The bid provider then uses the provider terminal 22 to access the platform server 41 via the Internet 6. Next, the bid provider gains access to a member web page 42W of the login server 42 and types personal data for membership application.

After becoming a member, a bid provider may gain access to the platform server 41 via the Internet 6. Next, it is connected to the login server 42. Next, user name and password are typed for identification. After being identified, the bid provider may gain access to the program database 461. Next, program codes of the invitation to bid program P3 are copied to the provider terminal 22 based on his or her rights and a desired bid mode. Next, the bid provider may use the provider terminal 22 to link to a provider blog 32. After successfully linking, the bid provider may copy program codes of the invitation to bid program P3 to the provider blog 32. Thus, program codes of the invitation to bid program P3 may be installed in the bid description web page 32W. Also, the guide tab of the invitation to bid program P3 is installed in the bid description web page 32W.

A bid provider may click the guide tab of the bid description web page 32W of the provider blog 32 to link the bid description web page 32W of the provider blog 32 to the platform server 41 of the online billing platform 4 via the Internet 6. Next, it is linked to the login server 42. Next, user name and password are typed for identification. After being identified, the bid provider is linked to the item server 43. Next, a number of pictures and accompanying description of available bids on the bid description web page 32W of the provider blog 32 are downloaded to the bid database 432 of the item server 43. Next, a bid file 432D is created in the bid database 432. Tab program codes PC are created in the program database 461. Next, the bid provider may obtain the tab program codes PC by linking to the program database 461. Next, the bid provider may use the provider terminal 22 to link to the provider blog 32 and copy the tab program codes PC to the provider blog 32. The bid confirmation tab and the information display tab are contained in the bid description web page 32W. A bidder (i.e., would-be buyer) may click the bid confirmation tab to start a bidding procedure. After starting the bidding procedure, the information display tab may show remaining time of collecting bids and bidder count on the bid description web page 32W immediately.

A plurality of bidding web pages 43W2 are created by the bid file 432D. Also, the bid confirmation tab, the information display tab, and a link tab are contained in the bidding web page 43W2. The bidder may click the bid confirmation tab to start a bidding procedure. Also, the bidder may click the link tab to link the platform server 41 of the online billing platform 4 to the bid description web page 32W of the provider blog 32 in order to view details of pictures and accompanying description of available bids. The information display tab may show remaining time of collecting bids and bidder count on the bidding web pages 43W2 immediately.

The bidder may use a user terminal 1 to link to a provider blog 32 so as to view the pictures and accompanying description of available bids on the bid description web page 32W of the provider blog 32. For bidding one or more desired items, the bidder may click the bid confirmation tab on the bid description web page 32W to start a bidding procedure when the time of collecting bids has not expired.

Alternatively, the bidder may use a user terminal 1 to link to a platform server 41 of the online billing platform 4 and in turn link to an item server 43 in order to view pictures and accompanying description of available bids on the bidding web page 43W2 of the item server 43. For bidding one or more items posted on the bidding web page 43W2, the bidder may click the bid confirmation tab on the bidding web page 43W2 to start a bidding procedure when the time of collecting bids has not expired.

Still alternatively, the bidder may click the link tab on the bidding web page 43W2 to link the platform server 41 to the bid description web page 32W in order to view pictures and accompanying description of available bids thereon.

The bid confirmation tab will be disabled immediately when the time of collecting bids has expired. A plurality of bid confirmation files with bid number 472D are created in the invitation to bid database 473. The e-mail server 45 sends an e-mail containing a payment tab to the bidder after finishing the bidding procedure based on the bid confirmation file with bid number 472D. The bidder may click the payment tab to start a payment procedure.

The method of online auction using blog further comprises the following steps:

The bid provider may use a provider terminal 22 to link to a platform server 41 of the online billing platform 4 and in turn link to a login server 42. Next, user name and password are typed for identification. After being identified, the bid provider may link to an e-mail server 45 to send a supplier file to a supplier database 454 of the e-mail server 45. And in turn, a corresponding supplier record file 454D is created. The e-mail server 45 of the online billing platform 4 may create an publication sending web page 45W2 based on the supplier record file 454D and the bid file 432D.

The bid provider may use a provider terminal 22 to link to a platform server 41 of the online billing platform 4 and in turn link to a login server 42. Next, user name and password are typed for identification. After being identified, the bid provider may link to a publication sending web page 45W2 of an e-mail server 45. Also, the bid provider is required to input a supplier list and bidding information on the publication sending web page 45W2 required for publication purposes. A delivery file 455D is created in the publication database 455 of the e-mail server 45 based on the supplier list and bidding information. The e-mail server 45 then sends the delivery file 455D to the bidder by e-mail. Note that the bid confirmation tab contained in the e-mail has been enabled. Hence, the bidder may click the bid confirmation tab to start a bidding procedure.

A bidding procedure involves the following steps: A bidder may click the bid confirmation tab to link to a platform server 41 of the online billing platform 4 and in turn link to a login server 42. Next, user name and password are typed for identification. After being identified, the bidder may link to a bid confirmation web page 47W3 of the transaction server 47. Also, the bidder is required to input bidding data on the bid confirmation web page 47W3. A bid confirmation file with bid number 473D is created in the invitation to bid database 473 of the transaction server 47 based on the bidding data.

Further, the e-mail server 45 sends an e-mail containing a bid confirmation message to the bidder after finishing the bidding procedure based on the bid confirmation file with bid number 473D. The transaction server 47 then links to the information display tab on the bid description web page 32W via the platform server 41. The transaction server 47 then updates bid count on the bid description web page 32W immediately based on the bid confirmation file with bid number 473D.

A payment procedure involves the following steps: A bidder may use the user terminal 1 to click the payment tab contained in the e-mailed bid confirmation message to link to a platform server 41 of the online billing platform 4 and in turn link to a login server 42. Next, user name and password are typed for identification. After being identified, the user may link to a bid payment web page 44W3 of a billing server 44. Also, the bid provider is required to input payment data on the bid payment web page 44W3. A bid list file with bid number 445D is created in the bid list database 445 of the billing server 44 based on the payment data.

The platform server 41 of the online billing platform 4 links to a bank terminal 5. The billing server 44 then verifies information (e.g., credit card information) provided in the bid list file with bid number 445D with a corresponding credit card issuing bank. After being verified, a transaction particulars file with bid number 442D is created in a bank database 442 of the billing server 44 based on an authorization from the bank. Also, a contract with bid number 446D is created in the bidding contract database 446 of the billing server 44.

The e-mail server 45 then sends the contract with bid number 446D to each of the winning bidder and the bid provider by e-mail.

The method of online auction using blog further comprises the following steps:

After winning the bid, the bidder may use a user terminal 1 to link to a platform server 41 of the online billing platform 4 and in turn link to a login server 42. Next, user name and password are typed for identification. After being identified, the bidder may link to a request for payment web page 44W2 of the billing server 44. Also, the bidder is required to input payment data on the request for payment web page 44W2. A debit note file with bid number 444D is created in the request for payment database 444 of the billing server 44 based on the payment data.

After being verified by a manager of the online billing platform 4, an invoice is prepared based on the debit note file with order number 444D. The invoice is finally issued to the buyer (i.e., the winning bidder) for request for payment.

While the invention herein disclosed has been described by means of specific embodiments, numerous modifications and variations could be made thereto by those skilled in the art without departing from the scope and spirit of the invention set forth in the claims.

What is claimed is:

1. A method of online auction comprising the steps of:
at a seller:
using a seller terminal (21) to access a seller blog (31) of a web server (3) over the Internet (6);
creating an item description web page (31W) in the seller blog (31);
posting at least one picture and accompanying description of items being auctioned on the item description web page (31W);
using the seller terminal (21) to access a platform server (41) of an online billing platform (4) via the Internet (6);
gaining access to a member web page (42W) of a login server (42) of the online billing platform (4);
typing personal data for membership application;
gaining access to the platform server (41) via the Internet (6);
linking to the login server (42);
logging in for gaining access to a program database (461) of a function server (46);
copying program codes of a group bidding tab program (P1) including a guide tab, a group bidding confirmation tab, and an information display tab to the seller terminal (21);
using the seller terminal (21) to link to the seller blog (31);
copying the program codes of the group bidding tab program (P1) to the seller blog (31);
installing the program codes of the group bidding tab program (P1) including the guide tab, the group bidding confirmation tab, and the information display tab in the item description web page (31W);
clicking the guide tab of the item description web page (31W) to link the item description web page (31W) to the platform server (41);
linking to the login server (42);
logging in for linking to an item server (43) of the online billing platform (4);
downloading the at least one picture and accompanying description of the items being auctioned on the item description web page (31W) to a merchandise database (431) of the item server (43);
creating a merchandise file (431D) in the merchandise database (431);
creating tab program codes (PC) in the program database (461);
obtaining the tab program codes (PC) by linking to the program database (461); and
using the seller terminal (21) to link to the seller blog (31) and copy the tab program codes (PC) to the seller blog (31);
at a representative for a bidding group:
clicking the group bidding confirmation tab to start a group bidding procedure;
causing the information display tab to show remaining time of collecting bids, current prices of the available items, and the number of the sold items on the item description web page (31W);
creating a merchandise sale web page (43W1) comprising the group bidding confirmation tab, the information display tab, and a link tab;
clicking the group bidding confirmation tab to start the group bidding procedure;
clicking the link tab to link the platform server (41) to the item description web page (31W) for viewing details of the at least one picture and accompanying description of the items being auctioned;
causing the information display tab to show remaining time of collecting bids, current prices of the available items, and the number of the sold items on the merchandise sale web page (43W1);
using a user terminal (1) to link to a seller blog (31) for viewing the at least one picture and accompanying description of the items being auctioned on the item description web page (31W);
clicking the group bidding confirmation tab on the item description web page (31W) to start the group bidding procedure for bidding at least one of the items when time of collecting bids has not expired; and
creating a group bidding confirmation file with group bid number (471D) in a group bidding database (471) of a transaction server (47) of the online billing platform (4) after winning the bid of at least one of the items;
sending an e-mail containing a payment tab from an e-mail server (45) of the online billing platform (4) to the representative based on the group bidding confirmation file with group bid number (471D);
causing the representative to click the payment tab to start a payment procedure which comprises using the user terminal (1) to click the payment tab contained in the e-mail to link to both the platform server (41) and the login server (42), log on for linking to a payment web page (44W1) of a billing server (44) of the online billing platform (4), and input payment data on the payment web page (44W1) to create a purchase order file with order number (441D) in a purchase order database (441) of the billing server (44);
causing the platform server (41) to link to a bank terminal (5) so that the billing server (44) is adapted to verify credit card information provided in the purchase order file with order number (441D) with a credit card issuing bank;
after being verified, creating a transaction particulars file with order number (442D) in a bank database (442) of the billing server (44) based on an authorization from the credit card issuing bank;
creating a shipment file with order number (443D) in a shipment database (443) of the billing server (44);
sending an e-mail containing the purchase order file with order number (441D) from the e-mail server (45) to the representative;
sending an e-mail containing instructions of preparing each of the ordered items for shipment from the e-mail server (45) to the seller based on the shipment file with order number (443D);
after the shipment, causing the seller to use the seller terminal (21) to link to both the platform server (41) and the login server (42), and log on for linking the seller terminal (21) to a request for payment web page (44W2) of the billing server (44) so as to require the seller to input request for payment data on the request for payment web page (44W2);
creating a debit note file with order number (444D) in a request for payment database (444) of the billing server (44) based on the request for payment data; and
after being verified by a manager of the online billing platform (4), preparing an invoice and sending same to the winning representative.

2. A method of online auction comprising the steps of:
at a seller:
using a seller terminal (21) to access a seller blog (31) of a web server (3) over the Internet (6);
creating an item description web page (31W) in the seller blog (31);
posting at least one picture and accompanying description of items being auctioned on the item description web page (31W);
using the seller terminal (21) to access a platform server (41) of an online billing platform (4) via the Internet (6);
gaining access to a member web page (42W) of a login server (42) of the online billing platform (4);
typing personal data for membership application;
gaining access to the platform server (41) via the Internet (6);
linking to the login server (42);
logging in for gaining access to a program database (461) of a function server (46);
copying program codes of an auction tab program (P2) including a guide tab, a bid price confirmation tab, and an information display tab to the seller terminal (21);
using the seller terminal (21) to link to the seller blog (31);
copying the program codes of the auction tab program (P2) to the seller blog (31);
installing the program codes of the auction tab program (P2) including the guide tab, the bid price confirmation tab, and the information display tab in the item description web page (31W);
clicking the guide tab of the item description web page (31W) to link the item description web page (31W) to the platform server (41);
linking to the login server (42);
logging in for linking to an item server (43) of the online billing platform (4);
downloading the at least one picture and accompanying description of the items being auctioned on the item description web page (31W) to a merchandise database (431) of the item server (43);
creating a merchandise file (431D) in the merchandise database (431);
creating tab program codes (PC) in the program database (461);
obtaining the tab program codes (PC) by linking to the program database (461); and
using the seller terminal (21) to link to the seller blog (31) and copy the tab program codes (PC) to the seller blog (31);
at a bidder:
clicking the bid price confirmation tab to start a group bidding procedure;
causing the information display tab to show remaining time of collecting bids, current prices of the available items, and the number of the sold items on the item description web page (31W);
creating a merchandise sale web page (43W1) comprising the bid price confirmation tab, the information display tab, and a link tab;
clicking the bid price confirmation tab to start the group bidding procedure;
clicking the link tab to link the platform server (41) to the item description web page (31W) for viewing details of the at least one picture and accompanying description of the items being auctioned;
causing the information display tab to show remaining time of collecting bids, current prices of the available items, and the number of the sold items on the merchandise sale web page (43W1);
using a user terminal (1) to link to a seller blog (31) for viewing the at least one picture and accompanying description of the items being auctioned on the item description web page (31W);
clicking the bid price confirmation tab on the item description web page (31W) to start the group bidding procedure for bidding at least one of the items when time of collecting bids has not expired; and
creating a bid price confirmation file with bid number (472D) in a auction database (472) of a transaction server (47) of the online billing platform (4) after winning the bid of at least one of the items;
sending an e-mail containing a payment tab from an e-mail server (45) of the online billing platform (4) to the bidder based on the bid price confirmation file with bid number (472D);
requesting the bidder to click the payment tab to start a payment procedure which comprises using the user terminal (1) to click the payment tab contained in the e-mail to link to both the platform server (41) and the login server (42), log on for linking to a payment web page (44W1) of a billing server (44) of the online billing platform (4), and input payment data on the payment web page (44W1) to create a purchase order file with order number (441D) in a purchase order database (441) of the billing server (44);
causing the platform server (41) to link to a bank terminal (5) so that the billing server (44) is adapted to verify credit card information provided in the purchase order file with order number (441D) with a credit card issuing bank;
after being verified, creating a transaction particulars file with order number (442D) in a bank database (442) of the billing server (44) based on an authorization from the credit card issuing bank;
creating a shipment file with order number (443D) in a shipment database (443) of the billing server (44);
sending an e-mail containing the purchase order file with order number (441D) from the e-mail server (45) to the bidder;
sending an e-mail containing instructions of preparing each of the ordered items for shipment from the e-mail server (45) to the seller based on the shipment file with order number (443D);
after the shipment, causing the seller to use the seller terminal (21) to link to both the platform server (41) and the login server (42), and log on for linking the seller terminal (21) to a request for payment web page (44W2) of the billing server (44) so as to require the seller to input request for payment data on the request for payment web page (44W2);
creating a debit note file with order number (444D) in a request for payment database (444) of the billing server (44) based on the request for payment data; and
after being verified by a manager of the online billing platform (4), preparing an invoice and sending same to the winning bidder.

3. A method of online auction comprising the steps of:
at a bid provider:
using a provider terminal (22) to access a provider blog (32) of a web server (3) over the Internet (6);
creating an bid description web page (32W) in the provider blog (32);
posting at least one picture and accompanying description of items being auctioned on the bid description web page (32W);
using the provider terminal (22) to access a platform server (41) of an online billing platform (4) via the Internet (6);
gaining access to a member web page (42W) of a login server (42) of the online billing platform (4);
typing personal data for membership application;
gaining access to the platform server (41) via the Internet (6);
linking to the login server (42);
logging in for gaining access to a program database (461) of a function server (46);
copying program codes of an invitation to bid program (P3) including a guide tab, a bid confirmation tab, and an information display tab to the provider terminal (22);
using the provider terminal (22) to link to the provider blog (32);
copying the program codes of the invitation to bid program (P3) to the provider blog (32);
installing the program codes of the invitation to bid program (P3) including the guide tab, the bid confirmation tab, and the information display tab in the bid description web page (32W);
clicking the guide tab of the bid description web page (32W) to link the bid description web page (32W) to the platform server (41);
linking to the login server (42);
logging in for linking to an item server (43) of the online billing platform (4);
downloading the at least one picture and accompanying description of the items being auctioned on the bid description web page (32W) to a bid database (432) of the item server (43);
creating a bid file (432D) in the bid database (432);
creating tab program codes (PC) in the program database (461);
obtaining the tab program codes (PC) by linking to the program database (461); and
using the provider terminal (22) to link to the provider blog (32) and copy the tab program codes (PC) to the provider blog (32);
at a bidder:
clicking the bid price confirmation tab to start a group bidding procedure;
causing the information display tab to show remaining time of collecting bids, current prices of the available items, and the number of the sold items on the bid description web page (32W);
creating a bidding web page (43W2) comprising the bid price confirmation tab, the information display tab, and a link tab;
clicking the bid price confirmation tab to start the group bidding procedure;
clicking the link tab to link the platform server (41) to the bid description web page (32W) for viewing details of the at least one picture and accompanying description of the items being auctioned;
causing the information display tab to show remaining time of collecting bids, current prices of the available items, and the number of the sold items on the bidding web page (43W2);
using a user terminal (1) to link to a provider blog (32) for viewing the at least one picture and accompanying description of the items being auctioned on the bid description web page (32W);
clicking the bid price confirmation tab on the bid description web page (32W) to start the group bidding procedure for bidding at least one of the items when time of collecting bids has not expired; and
creating a bid confirmation file with bid number (473D) in a invitation to bid database (473) of a transaction server (47) of the online billing platform (4) after winning the bid of at least one of the items;
sending an e-mail containing a payment tab from an e-mail server (45) of the online billing platform (4) to the bidder based on the bid confirmation file with bid number (473D);
requesting the bidder to click the payment tab to start a payment procedure which comprises using the user terminal (1) to click the payment tab contained in the e-mail to link to both the platform server (41) and the login server (42), log on for linking to a bid payment web page (44W3) of a billing server (44) of the online billing platform (4), and input payment data on the bid payment web page (44W3) to create a purchase order file with order number (441D) in a purchase order database (441) of the billing server (44);
causing the platform server (41) to link to a bank terminal (5) so that the billing server (44) is adapted to verify credit card information provided in the purchase order file with order number (441D) with a credit card issuing bank;
after being verified, creating a transaction particulars file with order number (442D) in a bank database (442) of the billing server (44) based on an authorization from the credit card issuing bank;
creating a shipment file with order number (443D) in a shipment database (443) of the billing server (44);
sending an e-mail containing the purchase order file with order number (441D) from the e-mail server (45) to the bidder;
sending an e-mail containing instructions of preparing each of the ordered items for shipment from the e-mail server (45) to the bid provider based on the shipment file with order number (443D);
after the shipment, causing the bid provider to use the provider terminal (22) to link to both the platform server (41) and the login server (42), and log on for linking the provider terminal (22) to a request for payment web page (44W2) of the billing server (44) so as to require the bid provider to input request for payment data on the request for payment web page (44W2);
creating a debit note file with order number (444D) in a request for payment database (444) of the billing server (44) based on the request for payment data; and
after being verified by a manager of the online billing platform (4), preparing an invoice and sending same to the winning bidder.
